(19) United States
(12) Patent Application Publication
(10) Pub. No.: US 2013/0113221 A1
(43) Pub. Date: May 9, 2013

(54) HOT DAY CYCLE

(71) Applicant: Timothy James Held, Akron, OH (US)

(72) Inventor: Timothy James Held, Akron, OH (US)

(73) Assignee: ECHOGEN POWER SYSTEMS, LLC, Akron, OH (US)

(21) Appl. No.: 13/290,735

(22) Filed: Nov. 7, 2011

(51) Int. Cl. F01K 13/00; H02K 7/18; F01K 25/10

(52) U.S. Cl. 290/1 R; 60/670; 60/671; 60/645

(57) ABSTRACT

A thermodynamic cycle is disclosed and has a working fluid circuit that converts thermal energy into mechanical energy on hot days. A pump circulates a working fluid to a heat exchanger that heats the working fluid. The heated working fluid is then expanded in a power turbine. The expanded working fluid is then cooled and condensed using one or more compressors interposing at least two intercooling components. The intercooling components cool and condense the working fluid with a cooling medium derived at ambient temperature, where the ambient temperature is above the critical temperature of the working fluid.

### BACKGROUND

Heat is often created as a byproduct of industrial processes where flowing streams of liquids, solids, or gasses containing heat must be exhausted into the environment or otherwise removed in some way in an effort to regulate the operating temperatures of the industrial process equipment. The industrial process oftentimes uses heat exchangers to capture the heat and recycle it back into the process via other process streams. Other times it is not feasible to capture and recycle the heat because it is either too hot or it may contain insufficient mass flow. This heat is referred to as “waste” heat and is typically discharged directly into the environment or indirectly through a cooling medium, such as water or air.

Waste heat can be converted into useful work by a variety of turbine generator systems that employ well-known thermodynamic cycles, such as the Rankine cycle. These thermodynamic methods are typically steam-based processes where the waste heat is recovered and used to generate steam from water in a boiler in order to drive a corresponding turbine. Organic Rankine cycles replace the water with a lower boiling-point working fluid, such as a light hydrocarbon like propane or butane, or a HCFC (e.g., R245fa) fluid. More recently, however, and in view of issues such as thermal instability, toxicity, or flammability of the lower boiling-point working fluids, some thermodynamic cycles have been modified to circulate more greenhouse-friendly and/or neutral working fluids, such as carbon dioxide (CO₂) or ammonia.

The efficiency of a thermodynamic cycle is largely dependent on the pressure ratio achieved across the system expander (or turbine). As this pressure ratio increases, so does the efficiency of the cycle. One way to alter the pressure ratio is to manipulate the temperature of the working fluid in the thermodynamic cycle, especially at the suction inlet of the cycle pump (or compressor). Heat exchangers, such as condensers, are typically used for this purpose, but conventional condensers are directly limited by the temperature of the cooling medium being circulated therein, which is frequently ambient air or water.

On hot days, when the temperature of the cooling medium is heightened, condensing the working fluid with a conventional condenser can be problematic. This is especially challenging in thermodynamic cycles having a working fluid with a critical temperature that is lower than the ambient temperature. As a result, the condenser can no longer condense the working fluid, and cycle efficiency inevitably suffers.

Accordingly, there exists a need in the art for a thermodynamic cycle that can efficiently and effectively operate with a working fluid that does not condense on hot days, thereby increasing thermodynamic cycle power output derived from not only waste heat but also from a wide range of other thermal sources.

### SUMMARY

Embodiments of the disclosure may provide a working fluid circuit for converting thermal energy into mechanical energy. The working fluid circuit may include a pump configured to circulate a working fluid through the working fluid circuit. A heat exchanger may be in fluid communication with the pump and in thermal communication with a heat source, and the heat exchanger may be configured to transfer thermal energy from the heat source to the working fluid. A power turbine may be fluidly coupled to the heat exchanger and configured to expand the working fluid discharged from the heat exchanger to generate the mechanical energy. Two or more intercooling components may be in fluid communication with the power turbine and configured to cool and condense the working fluid using a cooling medium derived at or near ambient temperature. One or more compressors may be fluidly coupled to the two or more intercooling components such that at least one of the one or more compressors is interposed between adjacent intercooling components.

Embodiments of the disclosure may also provide a method for regulating a pressure and a temperature of a working fluid in a working fluid circuit. The method may include circulating the working fluid through the working fluid circuit with a pump. The working fluid may be heated in a heat exchanger arranged in the working fluid circuit in fluid communication with the pump, and the heat exchanger may be in thermal communication with a heat source. The working fluid discharged from the heat exchanger may be expanded in a power turbine fluidly coupled to the heat exchanger. The working fluid discharged from the power turbine may be cooled and condensed in at least two intercooling components in fluid communication with the power turbine. The at least two intercooling components may use a cooling medium at an ambient temperature to cool the working fluid, and the ambient temperature may be above a critical temperature of the working fluid. The working fluid discharged from the two or more intercooling components may be compressed with one or more compressors fluidly coupled to the two or more intercooling components such that at least one of the one or more compressors is interposed between fluidly adjacent intercooling components.

Embodiments of the disclosure may further provide a working fluid circuit. The working fluid circuit may include a pump configured to circulate a carbon dioxide working fluid through the working fluid circuit. A waste heat exchanger may be in fluid communication with the pump and in thermal communication with a waste heat source, and the heat exchanger being configured to transfer thermal energy from the waste heat source to the carbon dioxide working fluid. A power turbine may be fluidly coupled to the heat exchanger and configured to expand the carbon dioxide working fluid discharged from the heat exchanger. A precooler may be fluidly coupled to the power turbine and configured to remove thermal energy from the carbon dioxide working fluid. A first compressor may be fluidly coupled to the precooler and configured to increase a pressure of the carbon dioxide working fluid. An intercooler may be fluidly coupled to the first compressor and configured to remove additional thermal energy from the carbon dioxide working fluid, and the first compressor may be fluidly interposing the precooler and the intercooler.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates an exemplary thermodynamic cycle, according to one or more embodiments of the disclosure.

FIG. 2 illustrates a pressure-enthalpy diagram for a working fluid.

FIG. 3 illustrates another exemplary thermodynamic cycle, according to one or more embodiments of the disclosure.

FIG. 4 illustrates another pressure-enthalpy diagram for a working fluid.

FIG. 5 illustrates a flowchart of a method for regulating the pressure and temperature of a working fluid in a working fluid circuit, according to one or more embodiments of the disclosure.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

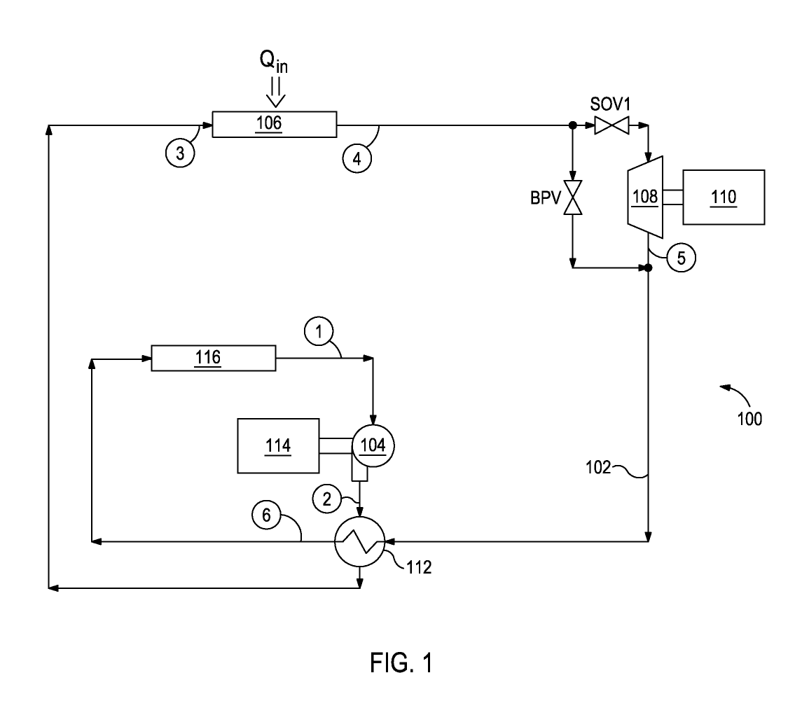

FIG. 1 illustrates a baseline recuperated “simple” thermodynamic cycle 100 that pumps a working fluid through a working fluid circuit 102 to produce power from a wide range of thermal sources. The thermodynamic cycle 100 may encompass one or more elements of a Rankine thermodynamic cycle and may operate as a closed-loop cycle, where the working fluid circuit 102 has a flow path defined by a variety of conduits adapted to interconnect the various components of the circuit 102. The circuit 102 may or may not be hermetically-sealed such that no amount of working fluid is leaked into the surrounding environment.

Although a simple thermodynamic cycle 100 is illustrated and discussed herein, those skilled in the art will recognize that other classes of thermodynamic cycles may equally be implemented into the present disclosure. For example, cascading and/or parallel thermodynamic cycles may be used, without departing from the scope of the disclosure. Various examples of cascading and parallel thermodynamic cycles that may apply to the present disclosure are described in co-pending PCT Pat. App. No. US2011/29486 entitled “Heat Engines with Cascade Cycles,” and co-pending U.S. patent application Ser. No. 13/212,631 entitled “Parallel Cycle Heat Engines,” the contents of which are each hereby incorporated by reference.

In one or more embodiments, the working fluid used in the thermodynamic cycle 100 is carbon dioxide (CO₂). It should be noted that use of the term CO₂ is not intended to be limited to CO₂ of any particular type, purity, or grade. For example, industrial grade CO₂ may be used without departing from the scope of the disclosure. In other embodiments, the working fluid may be a binary, ternary, or other working fluid blend. In other embodiments, the working fluid may be a combination of CO₂ and one or more other miscible fluids. In yet other embodiments, the working fluid may be a combination of CO₂ and propane, or CO₂ and ammonia, without departing from the scope of the disclosure.

Moreover, use of the term “working fluid” is not intended to limit the state or phase of the working fluid. For instance, the working fluid may be in a fluid phase, a gas phase, a supercritical state, a subcritical state or any other phase or state at any one or more points within the thermodynamic cycle 100. In one or more embodiments, the working fluid is in a supercritical state over certain portions of the thermodynamic cycle 100 (i.e., a high pressure side), and in a subcritical state at other portions of the thermodynamic cycle 100 (i.e., a low pressure side). In other embodiments, the entire thermodynamic cycle 100 may be operated such that the working fluid is maintained in either a supercritical or subcritical state throughout the entire working fluid circuit 102.

The thermodynamic cycle 100 may include a main pump 104 that pressurizes and circulates the working fluid throughout the working fluid circuit 102. The pump 104 can also be or include a compressor. The pump 104 drives the working fluid toward a heat exchanger 106 that is in thermal communication with a heat source Qᵢₙ. Through direct or indirect interaction with the heat source Qᵢₙ, the heat exchanger 106 increases the temperature of the working fluid flowing therethrough.

The heat source Qᵢₙ derives thermal energy from a variety of high temperature sources. For example, the heat source Qᵢₙ may be a waste heat stream such as, but not limited to, gas turbine exhaust, process stream exhaust, or other combustion product exhaust streams, such as furnace or boiler exhaust streams. The thermodynamic cycle 100 may be configured to transform this waste heat into electricity for applications ranging from bottom cycling in gas turbines, stationary diesel engine gensets, industrial waste heat recovery (e.g., in refineries and compression stations), and hybrid alternatives to the internal combustion engine. In other embodiments, the heat source Qᵢₙ may derive thermal energy from renewable sources of thermal energy such as, but not limited to, solar thermal and geothermal sources.

While the heat source Qᵢₙ may be a fluid stream of the high temperature source itself, in other embodiments the heat source Qᵢₙ may be a thermal fluid that is in contact with the high temperature source. The thermal fluid may deliver the thermal energy to the waste heat exchanger 106 to transfer the energy to the working fluid in the circuit 100.

A power turbine 108 is arranged downstream from the heat exchanger 106 and receives and expands the heated working fluid discharged from the heat exchanger 106. The power turbine 108 may be any type of expansion device, such as an expander or a turbine, and may be operatively coupled to an alternator or generator 110, or some other load receiving device configured to receive shaft work. The generator 110 converts the mechanical work provided by the power turbine 108 into usable electrical power.

The power turbine 108 discharges the working fluid toward a recuperator 112 fluidly coupled downstream thereof. The recuperator 112 transfers residual thermal energy in the working fluid to the working fluid initially discharged from the pump 104. Consequently, the temperature of the working fluid discharged from the power turbine 108 is decreased in the recuperator 112 and the temperature of the working fluid discharged from the pump 104 is simultaneously increased.

The pump 104 may be powered by a motor 114 or similar driver device. In other embodiments, the pump 104 may be operatively coupled to the power turbine 108 or some other expansion device in order to drive the pump 104. Embodiments where the pump 104 is driven by the turbine 108 or another drive turbine (not shown) are described in co-pending U.S. patent application Ser. No. 13/205,082 entitled “Driven Starter Pump and Start Sequence,” the contents of which are hereby incorporated by reference to the extent consistent with this disclosure.

A condenser 116 is fluidly coupled to the recuperator 112 and configured to condense the working fluid by further reducing its temperature before reintroducing the liquid or substantially-liquid working fluid to the pump 104. The cooling potential of the condenser 116 is directly dependent on the temperature of its cooling medium, which is usually ambient air or water circulated therein. Depending on the resulting temperature and pressure at the suction inlet of the pump 104, the working fluid may be either subcritical or supercritical at this point.

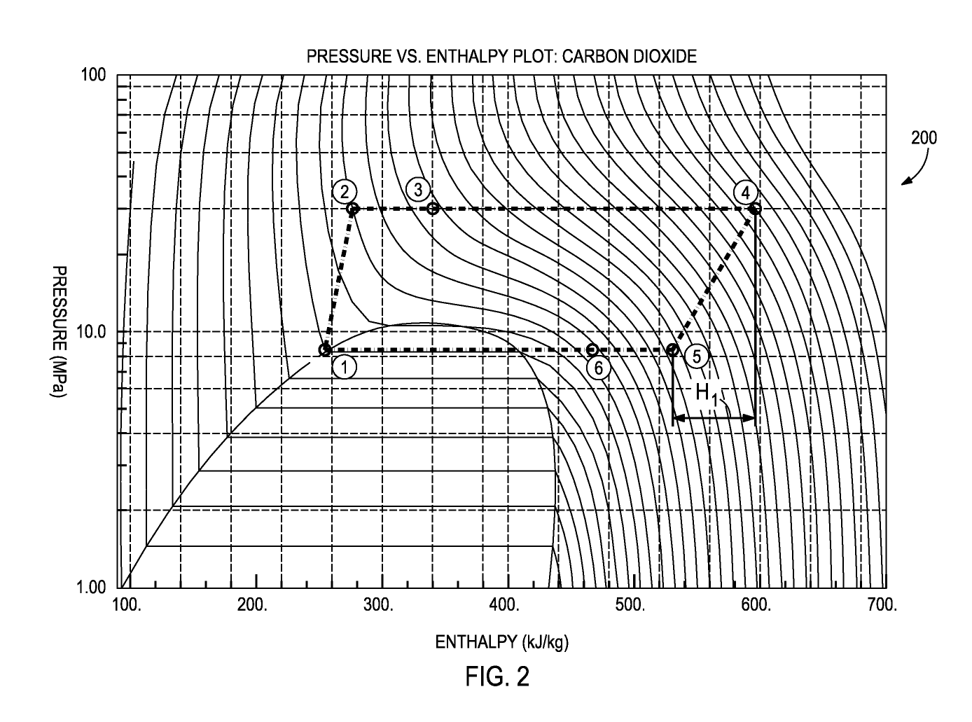

Referring to FIG. 2, with continued reference to FIG. 1, the thermodynamic cycle 100 may be described with reference to a pressure-enthalpy diagram 200 corresponding to the working fluid in the working fluid circuit 102. For example, the diagram 200 depicts the pressure-enthalpy plot for CO₂ circulating throughout the fluid circuit 102 on a standard temperature day (e.g., about 20° C.). The various points 1-6 indicated in FIG. 2 correspond to equivalent locations 1-6 depicted throughout the fluid circuit 102 in FIG. 1. Point 1 is indicative of the working fluid adjacent the suction inlet of the pump 104, as indicated in FIG. 1, and at this point the working fluid exhibits its lowest pressure and enthalpy compared to any other point in the cycle 100. At point 1, the working fluid may be in a liquid or substantially-liquid phase. As the working fluid is pumped or otherwise compressed to a higher pressure, its state moves from point 1 to point 2 on the diagram 200, or downstream from the pump 104, as indicated in FIG. 1.

Thermal energy is initially and internally introduced to the working fluid via the recuperator 112, which moves the working fluid from point 2 to point 3 at a constant pressure. Additional thermal energy is externally added to the working fluid via the heat exchanger 106, which moves the working fluid from point 3 to point 4. As thermal energy is introduced to the working fluid, both the temperature and enthalpy of the working fluid increase.

At point 4, the working fluid is at or adjacent the inlet to the power turbine 108. As the working fluid is expanded across the power turbine 108 to point 5, its temperature and enthalpy is reduced representing the work output derived from the expansion process. Thermal energy is subsequently removed from the working fluid in the recuperator 112, thereby moving the working fluid from point 5 to point 6. Point 6 is indicative of the working fluid being downstream from the recuperator 112 and/or near the inlet to the condenser 116. Additional thermal energy is removed from the working fluid in the condenser 116 and thereby moves from point 6 back to point 1 in a fluid or substantially-fluid state.

The work output for the cycle 100 is directly related to the pressure ratio achievable across the power turbine 108 and the amount of enthalpy loss realized as the working fluid is expanded from point 4 to point 5. As illustrated, a first enthalpy loss H₁ is realized as the working fluid is expanded from point 4 to point 5, and represents the work output for the cycle 100 using CO₂ as the working fluid on a standard temperature day.

As will be appreciated, each process (i.e., 1-2, 2-3, 3-4, 4-5, 5-6, and 6-1) need not occur exactly as shown on the exemplary diagram 200, and instead each step of the cycle 100 could be achieved in a variety of ways. For example, those skilled in the art will recognize that it is possible to achieve a variety of different coordinates on the diagram 200 without departing from the scope of the disclosure. Similarly, each point on the diagram 200 may vary dynamically over time as variables within, and external to, the cycle 100 change, such as ambient temperature, heat source Qᵢₙ temperature, amount of working fluid in the system, combinations thereof, etc. In one embodiment, the working fluid may transition from a supercritical state to a subcritical state (i.e., a transcritical cycle) between points 4 and 5. In other embodiments, however, the pressures at points 4 and 5 may be selected or otherwise manipulated such that the working fluid remains in a supercritical state throughout the entire cycle 100.

The efficiency of the thermodynamic cycle 100 is dependent at least in part on the pressure ratio achieved across the power turbine 108; the higher the pressure ratio, the higher the efficiency of the cycle 100. This pressure ratio can be maximized by manipulating the temperature of the working fluid in the working fluid circuit 102, especially at the suction inlet of the pump 104 (i.e., point 1) which is primarily cooled using the condenser 116.

On hot days, however, the cooling potential of the condenser 116 is lessened since the cooling medium (e.g., ambient air or water) circulates at a higher temperature and is therefore unable to condense or otherwise cool the working fluid as efficiently as at cooler ambient temperatures. As used herein, “hot” refers to ambient temperatures that are close to (i.e., within 5° C.) or higher than the critical temperature of the working fluid. For example, the critical temperature for CO₂ is approximately 31° C., and on a hot day the cooling medium can be circulated in the condenser 116 at temperatures greater than 31° C.

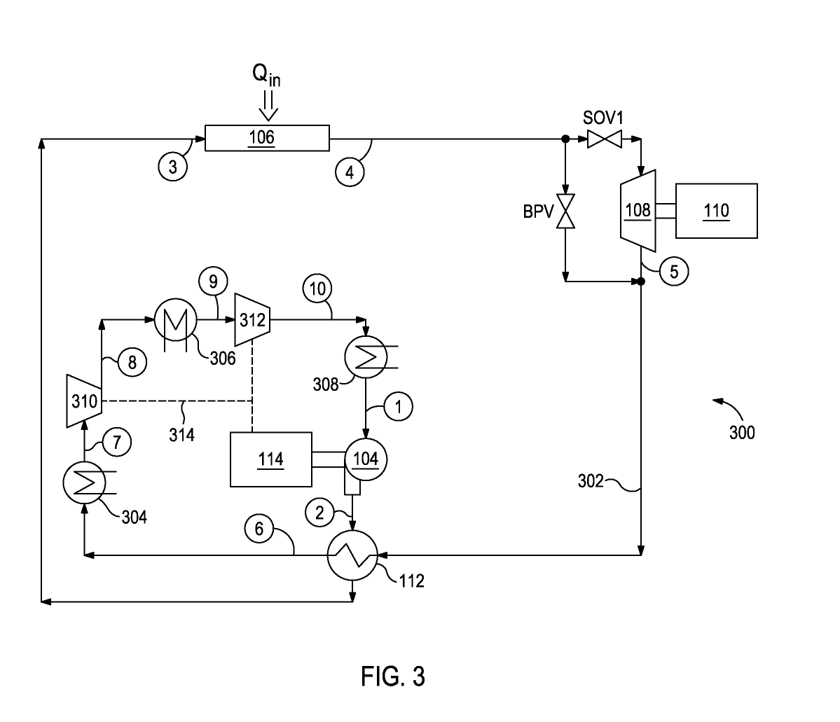

In order to anticipate or otherwise mitigate the adverse effects of hot day temperatures, FIG. 3 illustrates another thermodynamic cycle 300, according to one or more embodiments. The cycle 300 may be substantially similar to the thermodynamic cycle 100 described above with reference to FIG. 1, and therefore may be best understood with reference thereto where like numerals indicate like components that will not be described again in detail. The cycle 300 includes a working fluid circuit 302 that fluidly couples the various components. Instead of using a condenser 116 to cool and condense the working fluid, however, the working fluid circuit 302 pumps or otherwise compresses the working fluid in multiple steps, implementing intercooling stages between each step.

Specifically, the working fluid circuit 302 includes a precooler 304, an intercooler 306, and a cooler (or condenser) 308, collectively, the intercooling components 304, 306, 308. The intercooling components 304, 306, 308 are configured to cool the working fluid stagewise instead of in one step. In other words, as the working fluid successively passes through each intercooling component 304, 306, 308, the temperature of the working fluid is progressively decreased.

The cooling medium used in each intercooling component 304, 306, 308 may be air or water at or near (i.e., +/−5° C.) ambient temperature. The cooling medium for each intercooling component 304, 306, 308 may originate from the same source, or the cooling medium may originate from different sources or at different temperatures in order to optimize the power output from the circuit 302. In embodiments where ambient water is the cooling medium, one or more of the intercooling components 304, 306, 308 may be printed circuit heat exchangers, shell and tube heat exchangers, plate and frame heat exchangers, brazed plate heat exchangers, combinations thereof, or the like. In embodiments where ambient air is the cooling medium, one or more of the intercooling components 304, 306, 308 may be direct air-to-working fluid heat exchangers, such as fin and tube heat exchangers or the like.

The working fluid circuit 302 also includes a first compressor 310 and a second compressor 312 in fluid communication with the intercooling components 304, 306, 308. The first compressor 310 interposes the precooler 304 and the intercooler 306, and the second compressor interposes the intercooler 306 and the cooler 308. The working fluid passing through each compressor 310, 312 may be in a substantially gaseous or supercritical phase.

The compressors 310, 312 may be independently driven using one or more external drivers (not shown), or may be operatively coupled to the motor 114 via a common shaft 314. In at least one embodiment, one or both of the compressors 310, 312 is directly driven by a drive turbine (not shown), or any of the turbines (expanders) in the fluid circuit 302. The compressors 310, 312 may be centrifugal compressors, axial compressors, or the like.

Although two compressors 310, 312 and three intercooling components 304, 306, 308 are illustrated and described herein, those skilled in the art will readily recognize that any number of compression stages with intercoolers can be implemented, without departing from the scope of the disclosure. For example, embodiments contemplated herein include having only the precooler 304 and intercooler 306 interposed by the first compressor 310, where the intercooler 306 is fluidly coupled to the pump 104 for recirculation. Other embodiments may include more than one compressor interposing fluidly adjacent intercooling components 304, 306 or 306, 308.

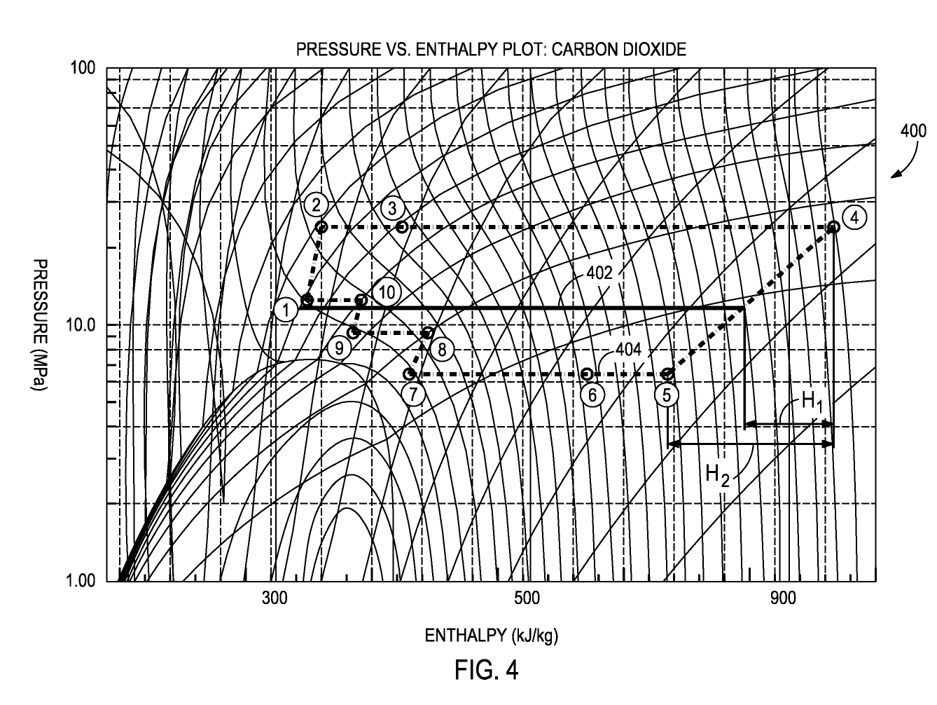

Referring to FIG. 4, with continued reference to FIG. 3, the thermodynamic cycle 300 may be described with reference to a pressure-enthalpy diagram 400 corresponding to CO₂ as the working fluid. The diagram 400 shows the pressure-enthalpy path that CO₂ will generally traverse in the fluid circuit 302 on a hot day (e.g., about 45° C.). Moreover, the diagram 400 compares a first loop 402 and a second loop 404, where both loops 402, 404 circulate CO₂ as the working fluid and are illustrated together in order to emphasize the various differences. The first loop 402 is generally indicative of the thermodynamic cycle 100 of FIG. 1, where the condenser 116 uses a cooling medium at about 45° C. to cool the working fluid before it is reintroduced into the pump 104. The second loop 404 is indicative of the thermodynamic cycle 300 of FIG. 3, where the working fluid is compressed and cooled stagewise with the compressors 310, 312 interposing the intercooling components 304, 306, 308 using a cooling medium at about 45° C.

The various points depicted in the diagram 400 (1-10) generally correspond to the similarly-numbered locations in the working fluid circuit 302 as indicated in FIG. 3. Points 1-6 are substantially similar to points 1-6 shown in FIG. 2 and described therewith, and therefore will not be described again in detail. Point 6 is indicative of the working fluid downstream from the recuperator 112 and/or near the inlet to the precooler 304. Thermal energy is removed from the working fluid in the precooler 304, thereby decreasing the enthalpy of the working fluid at a substantially constant pressure and moving the working fluid from point 6 to point 7. Point 7 is indicative of at or adjacent the inlet to the first compressor 310. The first compressor 310 increases the pressure of the working fluid and slightly increases its temperature and enthalpy, as it moves from point 7 to point 8.

Additional thermal energy is then removed from the working fluid in the intercooler 306, thereby decreasing the enthalpy of the working fluid again at a substantially constant pressure and moving the working fluid from point 8 to point 9. Point 9 is indicative of at or adjacent the inlet to the second compressor 312, which increases the pressure and temperature of the working fluid as it moves from point 9 to point 10. Additional thermal energy is removed from the working fluid in the cooler (condenser) 308, thereby further decreasing the enthalpy of the working fluid at a substantially constant pressure and moving the working fluid from point 10 back to point 1 in a fluid or substantially-fluid state.

As can be seen in the diagram 400, point 1 in the second loop 404 is substantially adjacent corresponding point 1 for the first loop 402. Accordingly, the process undertaken in the second loop 404, which represents the gas-phase compression with intercooling stages, results in substantially the same start point as the process undertaken in the first loop 402, which represents using the condenser 116 described with reference to FIG. 1. One of the significant differences between the two loops 402, 404, however, is the resulting work output of each loop 402, 404. The work output is directly related to the pressure ratio of each loop 402, 404 and represented in the diagram 400 by the amount of enthalpy loss realized in each cycle 100, 300, respectively, as the working fluid is expanded across the power turbine 108 from point 4 to point 5.

For instance, the first loop 402 realizes a first enthalpy loss H₁ as the working fluid is expanded, and the second loop 404 realizes a second, larger enthalpy loss H₂ as the working fluid is expanded across a greater differential. Although the second loop 404 requires more compression steps than the first loop 402 (which only requires one compression step at the pump 104) to return to point 1, the compression ratio of the second loop 404, as measured from point 4 to point 5, is much larger than the compression ratio of the first loop 402. Consequently, the work output of the second loop 404 is much larger than the work output of the first loop 402, and makes up for the multiple compression stages and otherwise surpasses the net work output of the first loop 402 on hot days. In other words, while increasing the pressure ratio between points 4 and 5 requires additional compression work, it simultaneously supplies a greater work output than what would otherwise be achievable using the single compression method represented by the first loop 402.

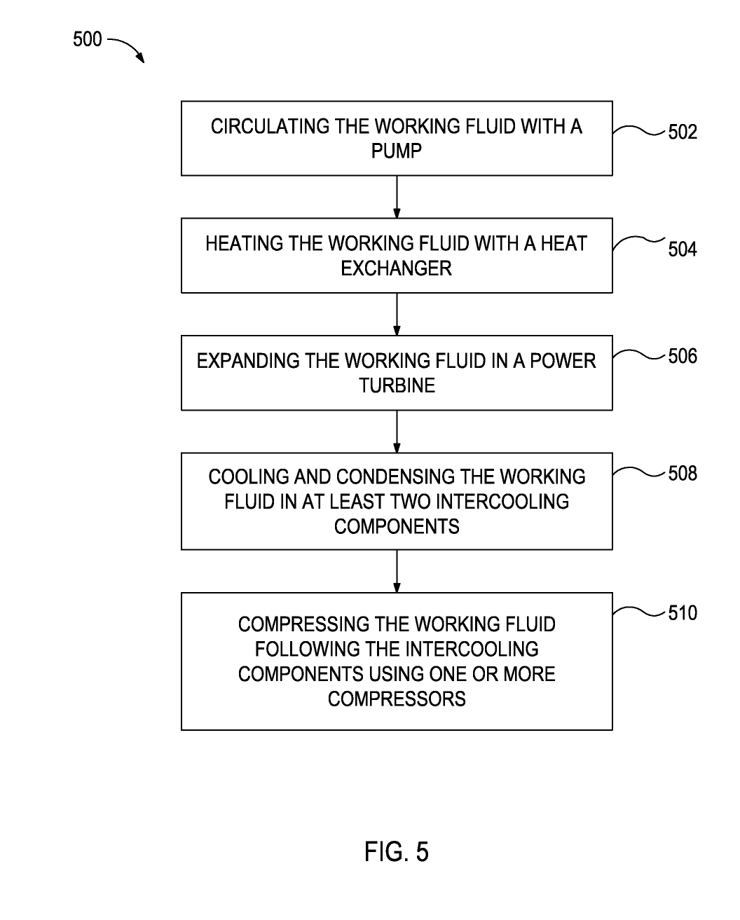

Referring now to FIG. 5, illustrated is a method 500 for regulating the pressure and temperature of a working fluid in a working fluid circuit. The method 500 may include circulating the working fluid through the working fluid circuit with a pump, as at 502. The working fluid may then be heated in a heat exchanger, as at 504. The heat exchanger is arranged in the working fluid circuit and in fluid communication with the pump. The heat exchanger is also in thermal communication with a heat source in order to heat the working fluid. After being discharged from the heat exchanger, the working fluid may be expanded in a power turbine, as at 506. The power turbine may be fluidly coupled to the heat exchanger.

The method 500 may also include cooling and condensing the working fluid discharged from the power turbine in at least two intercooling components, as at 508. The intercooling components may be in fluid communication with the power turbine and cool the working fluid using a cooling medium at ambient temperature. In one embodiment, the ambient temperature is above the critical temperature of the working fluid. The working fluid is compressed following the intercooling components using one or more compressors, as at 510. At least one of the one or more compressors is interposed between fluidly adjacent intercooling components.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A working fluid circuit for converting thermal energy into mechanical energy, comprising:
a pump configured to circulate a working fluid through the working fluid circuit;
a heat exchanger in fluid communication with the pump and in thermal communication with a heat source, the heat exchanger being configured to transfer thermal energy from the heat source to the working fluid;
a power turbine fluidly coupled to the heat exchanger and configured to expand the working fluid discharged from the heat exchanger to generate the mechanical energy;
two or more intercooling components in fluid communication with the power turbine and configured to cool and condense the working fluid using a cooling medium derived at or near ambient temperature; and
one or more compressors fluidly coupled to the two or more intercooling components such that at least one of the one or more compressors is interposed between adjacent intercooling components.

2. The working fluid circuit of claim 1, wherein the working fluid is carbon dioxide.

3. The working fluid circuit of claim 2, wherein the carbon dioxide is supercritical over at least a portion of the working fluid circuit.

4. The working fluid circuit of claim 1, further comprising a generator coupled to the power turbine to convert the mechanical energy into electricity.

5. The working fluid circuit of claim 1, wherein the cooling medium is air or water.

6. The working fluid circuit of claim 1, wherein the ambient temperature is within about 5° C. of a critical temperature of the working fluid or above the critical temperature of the working fluid.

7. The working fluid circuit of claim 1, further comprising a recuperator fluidly coupled to the power turbine and in fluid communication with the two or more intercooling components, the recuperator being configured to transfer thermal energy from the working fluid discharged from the power turbine to the working fluid discharged from the pump.

8. The working fluid circuit of claim 1, wherein the two or more intercooling components include a precooler, an intercooler, and a condenser.

9. The working fluid circuit of claim 8, wherein the one or more compressors include a first compressor and a second compressor, the first compressor interposing the precooler and the intercooler, and the second compressor interposing the intercooler and the condenser.

10. The working fluid circuit of claim 1, wherein the one or more compressors are operatively coupled together and driven by a common motor.

11. A method for regulating a pressure and a temperature of a working fluid in a working fluid circuit, comprising:
circulating the working fluid through the working fluid circuit with a pump;
heating the working fluid in a heat exchanger arranged in the working fluid circuit in fluid communication with the pump, the heat exchanger being in thermal communication with a heat source;
expanding the working fluid discharged from the heat exchanger in a power turbine fluidly coupled to the heat exchanger;
cooling and condensing the working fluid discharged from the power turbine in at least two intercooling components in fluid communication with the power turbine, the at least two intercooling components using a cooling medium at an ambient temperature to cool the working fluid, wherein the ambient temperature is above a critical temperature of the working fluid; and
compressing the working fluid discharged from the two or more intercooling components with one or more compressors fluidly coupled to the two or more intercooling components such that at least one of the one or more compressors is interposed between fluidly adjacent intercooling components.

12. The method of claim 11, further comprising transferring thermal energy from the working fluid discharged from the power turbine to the working fluid discharged from the pump using a recuperator fluidly coupled to the power turbine and the two or more intercooling components.

13. The method of claim 11, further comprising driving the one or more compressors with a common motor having a common shaft operatively coupled to the one or more compressors.

14. The method of claim 11, wherein expanding the working fluid discharged from the heat exchanger in the power turbine further comprises extracting mechanical work from the power turbine.

15. A working fluid circuit, comprising:
a pump configured to circulate a carbon dioxide working fluid through the working fluid circuit;
a waste heat exchanger in fluid communication with the pump and in thermal communication with a waste heat source, the heat exchanger being configured to transfer thermal energy from the waste heat source to the carbon dioxide working fluid;
a power turbine fluidly coupled to the heat exchanger and configured to expand the carbon dioxide working fluid discharged from the heat exchanger;
a precooler fluidly coupled to the power turbine and configured to remove thermal energy from the carbon dioxide working fluid;
a first compressor fluidly coupled to the precooler and configured to increase a pressure of the carbon dioxide working fluid; and
an intercooler fluidly coupled to the first compressor and configured to remove additional thermal energy from the carbon dioxide working fluid, the first compressor fluidly interposing the precooler and the intercooler.

16. The working fluid circuit of claim 15, further comprising:
a second compressor fluidly coupled to the intercooler and configured to further increase the pressure of the carbon dioxide working fluid; and
a cooler fluidly coupled to the second compressor and configured to remove additional thermal energy from the carbon dioxide working fluid, the cooler discharging the carbon dioxide working fluid in a substantially fluid state.

17. The working fluid circuit of claim 16, wherein the first and second compressors are operatively coupled together via a common shaft and driven by a common motor.

18. The working fluid circuit of claim 15, wherein the carbon dioxide working fluid is supercritical over at least a portion of the working fluid circuit.

19. The working fluid circuit of claim 15, further comprising a recuperator in fluid communication with the power turbine and the precooler, the recuperator being configured to transfer thermal energy from the carbon dioxide working fluid discharged from the power turbine to the carbon dioxide working fluid discharged from the pump.

20. The working fluid circuit of claim 15, wherein the cooling medium is ambient air or ambient water
